(19) United States
(12) Patent Application Publication
(10) Pub. No.: US 2016/0334300 A1
(43) Pub. Date: Nov. 17, 2016

(54) Hydrostatic Pressure Test Method

(71) Applicant: HilFlo, LLC, Conroe, TX (US)

(72) Inventors: Clifford Lee Hilpert, Conroe, TX (US); Lewis Jackson Dutel, Houston, TX (US); Laura Tufts Meyer, Sealy, TX (US); Jeffery Lee Hilpert, Sealy, TX (US); David William Blacklaw, Houston, TX (US); Matteo Giovanni Batista, Farmingham, MA (US)

(73) Assignee: HilFlo, LLC, Conroe, TX (US)

(21) Appl. No.: 15/151,323

(22) Filed: May 10, 2016

Related U.S. Application Data
(63) Continuation-in-part of application No. 14/932,727, filed on Nov. 4, 2015.
(60) Provisional application No. 62/159,429, filed on May 11, 2015.

(51) Int. Cl. G01M 3/28; E21B 33/06

(52) U.S. Cl. CPC G01M 3/2876; E21B 33/06

(57) ABSTRACT

A method and apparatus for testing closed hydraulic systems such as a blowout preventer for leaks maintain a constant pressure in the portion of the hydraulic system to be tested. A variable displacement pump is connected to the system for maintaining a constant pressure within the system. Any amount of fluid introduced into or removed from the blowout preventer in order to maintain constant pressure is measured and is an indication of the leak rate in the closed hydraulic system.

### CROSS-REFERENCE TO RELATED APPLICATIONS

This application claims priority to U.S. provisional application Ser. No. 62/159,429 filed May 11, 2015, and is a continuation in part of U.S. application Ser. No. 14/932,727 filed Nov. 4, 2015. The entire contents of both applications is hereby expressly incorporated herein by reference thereto.

### BACKGROUND OF THE INVENTION

1. Field of the Invention

This application is directed to a method of testing a closed hydraulic system for example a blowout preventer (BOP) assembly for leaks. The Oil and Gas Exploration risk management includes the ability to control subsurface pressures which may be encountered during drilling operation. The primary mechanism utilized by operators to control downhole pressures is the hydrostatic pressure as a result of the drilling fluid contained within the wellbore. The drilling fluid is engineered and formulated to a density that provides a hydrostatic pressure inside of the wellbore that is greater than the formation pressure being drilled. In the majority of drilling operations, the hydrostatic control of wellbore pressure is adequate. However, from time-to-time the operator may encounter a higher than expected formation pressure where there is not adequate hydrostatic pressure to control the wellbore pressure. During these times the operator relies on a series of mechanical controls to stabilize the wellbore and prevent a “Blow Out”. A blow out is the uncontrolled release of fluid or gas from the wellbore. This event is extremely dangerous and therefore must be avoided if at all possible. The primary mechanical control device utilized by operators to control wellbore pressure is the Blowout Preventer (BOP) assembly. The BOP assembly consists of multiple sealing and shearing devices that are hydraulically actuated to provide various means of sealing around the drill string or shearing it off entirely, completely sealing the wellbore. It is essential that the BOP assembly operate as designed during these critical operations. Therefore it is a regulatory requirement to test the functionality and the integrity of the BOP assembly before starting drilling operations and at specific events during the drilling operations.

2. Description of Related Arts Invention

The BOP assembly test is a series of pressure tests at a minimum of two pressure levels, low pressure and high pressure. During the pressure test, fluid from an intensification pump is introduced into the closed BOP assembly in a volume sufficient to cause the internal pressure within the closed BOP assembly to rise to the first pressure test level. Once the first pressure test level is established the high pressure pump system is isolated from the closed BOP assembly and the pressure is monitored for a specified time period. During the monitoring phase the pressure decay is determined and compared to the pressure decay specification. A typical specification for compliance allows for a pressure decay rate of no more than 5 psi/minute or 25 psi total over the entirety of the five minute test.

The monitoring phase compromises two distinctly different steps. The initial step of the monitoring phase immediately follows the pressurization phase of the hydrostatic test and precedes the actual pressure decay test step of the monitoring phase. During this first step of the monitoring phase the internal pressure of the BOP is allowed, over a period of time, to stabilize. Thermal and mechanical changes caused by the pressurization phase of the hydrostatic test can result in large pressure changes immediately following the pressurization phase. The stabilization step is required to allow thermal and mechanical changes caused by the pressurization to subside so as to not influence the pressure decay test step of the monitoring phase.

FIG. 1 depicts a chart representative of a typical 250 psi low pressure hydrostatic test. The period between point 1 and point 2 is the pressurization phase. The period between point 2 and point 3 is the first step of the monitoring phase. The period between point 3 and point 4 is the second step of the monitoring phase. The period between point 4 and point 5 is the dump phase where pressure is released to complete the hydrostatic test process. Again referring to FIG. 1, the pressurization phase takes approximately 1 minute. The first step of the monitoring phase takes approximately 4 minutes and the second step of the monitoring phase takes approximately 5 minutes. The time to complete the dump phase is minimal and accomplished in less than 10 seconds. The total test time is approximately 9 minutes. Utilizing current technology the monitoring phase is approximately 90% of the total test time. In addition current pressure decay technology is an inherently inaccurate, indirect indication of leak rate. It would be much more desirable to utilize a new and unique test method where a substantial portion of the monitoring phase was eliminated and a means of directly measuring the leak rate was provided for. Thus there remains a need for a hydrostatic test method that mitigates the thermal and mechanical effects immediate subsequent to the pressurization phase and provides a means for direct measurement of the leak rate.

### BRIEF SUMMARY OF THE INVENTION

The improved hydrostatic test method of the current invention utilizes a means of applying a continuous nearly constant pressure approximately equal to the specified test pressure immediately subsequent to the pressurization phase. Additionally and optionally the rate of pressurization during the portion of the pressurization phase immediately preceding the monitoring phase is controlled and optimized to mitigate the undesirable effects of temperature and mechanical changes. Immediately subsequent to reaching the target pressure the pressure is held relatively constant for approximately 30 seconds by adding or subtracting intensification fluid as needed to maintain the test pressure. The volume of intensification fluid required to maintain a constant pressure during this period is directly related to the amount of intensification fluid lost through the leak of the BOP assembly. The volume over time will yield a leak rate.

### BRIEF DESCRIPTION OF SEVERAL VIEWS OF THE DRAWINGS

For a detailed description of the preferred embodiments of the invention, reference will now be made to the accompanying drawings in which:

FIG. 1 is a graph showing the time pressure time cycle of the prior art testing method.

FIG. 2 is a graph showing the pressure time cycle for the testing method accordingly to an embodiment of the invention.

FIG. 3 is a schematic view of an apparatus for carrying out an embodiment of the invention.

FIG. 4 is a schematic view of a control system for the apparatus shown in FIG. 3.

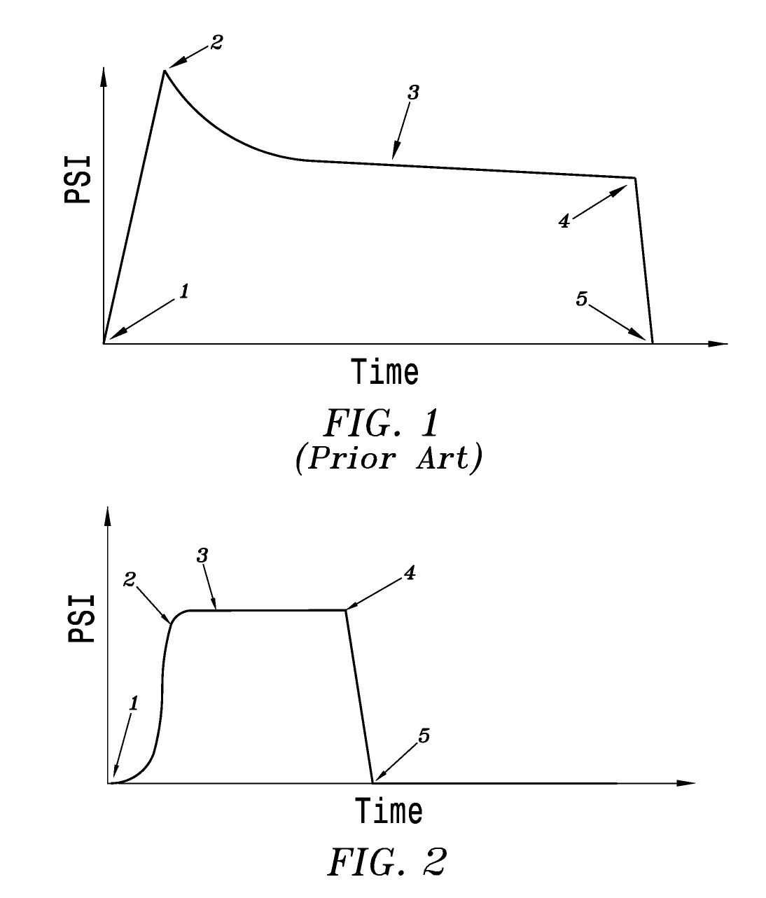

### DETAILED DESCRIPTION OF AN EMBODIMENT OF THE INVENTION

FIG. 2 depicts a chart representative of the new and unique hydrostatic testing method. As depicted in the chart of FIG. 2 the period between line 1 and line 2 is the initial component of the pressurization phase. The period between line 2 and line 3 is the transitional component of pressurization phase. The period between line 3 and line 4 is the monitoring phase. The period between line 4 and line 5 is the dump phase. The initial component of the pressurization phase takes approximately 45 seconds. The transitional component of the pressurization phase takes approximately 15 seconds. The monitoring phase takes approximately 30 seconds. The time to complete the dump phase is minimal and accomplished in less than 10 seconds.

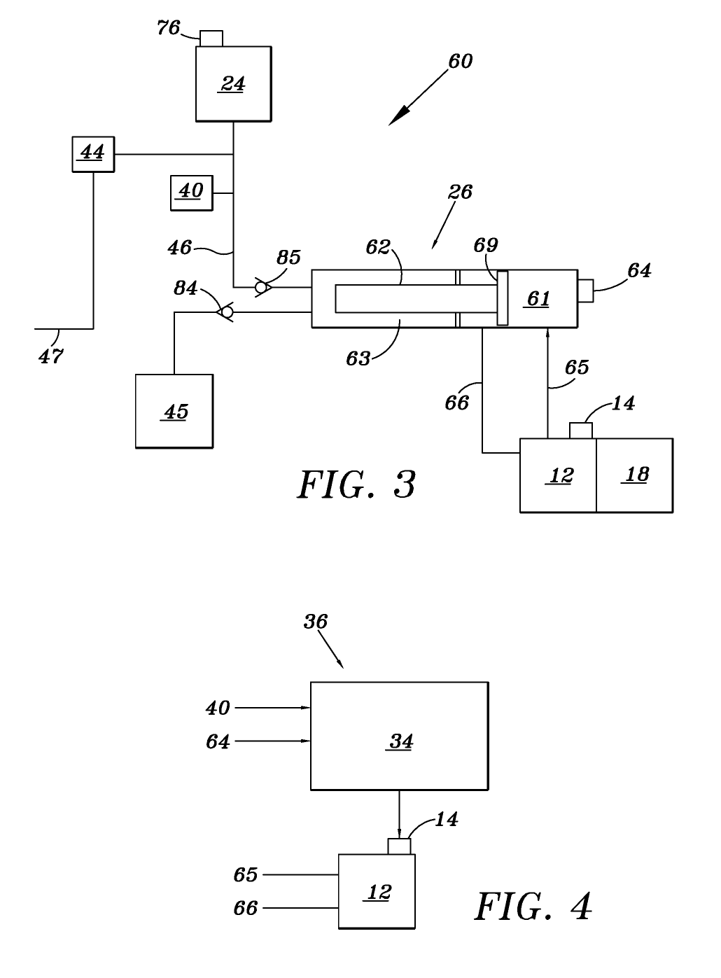

FIG. 3 is a schematic of an embodiment of apparatus for carrying out an embodiment of the invention. FIG. 3 is taken from U.S. patent application Ser. No. 14/932,727 filed Nov. 4, 2015, the entire contents of which is expressly incorporated herein by reference thereto.

In this embodiment an intensifying pump 26 which is of a well-known design includes a plunger 62 located in a hydrostatic chamber 63. A piston 69 is attached to the plunger 62 and is positioned within the hydraulic chamber 61.

A variable displacement hydraulic pump 12 which is driven by a prime motive source such as an electric motor 18 drives intensifier pump 26 via hydraulic lines 66 and 65 which are connected to the hydraulic power chamber 61 on either side of piston 69.

Variable displacement pump 12 may be of the type having a variable swash plate the position of which is controlled by a valve 14 in a manner known in the art.

Water from a reservoir 45 is drawn into hydrostatical chamber 63 through check valve 84 on the intake stroke of plunger 62 and is then directed to the blowout preventer 24 via check valve 85 and a conduit 46 during the exhaust stroke of the pump.

Pressure sensor 40 is located in conduit 46 and dump valve 44 is connected to conduit 46 for relieving pressure within the blowout preventer

This embodiment utilizes a single pump for pressurizing the blowout preventer, however a plurality of pumps may also be used. The same pump can also be used to maintain the pressure within the blowout preventer during the test to measure the addition of any fluid necessary to maintain constant pressure within the portion of the blowout preventer.

Should the pressure decrease during the test, controller 34 as shown in FIG. 4 as a result of a signal from pressure transducer 40 will send a signal to valve 14 to increase the pressure from variable displacement pump 12. This will cause piston 69 of intensifier pump 63 to move a finite distance which corresponds to the amount of fluid added to the blowout preventer in order to maintain constant pressure. This distance is sensed by sensor 64 and the information is sent to controller 34 for processing.

The test method according to an embodiment of the invention includes a first phase further including a means of providing intensification fluid in a volume sufficient to cause the initial pressurization of a vessel such as a BOP. The method of pressurization includes a means for monitoring and controlling the rate of pressurization. The rate of pressurization is optimized during the initial component of the pressurization phase to initially provide the highest possible rate of pressurization within the design limitations of the intensification apparatus and then subsequently to the transitional component of the pressurization phase that mitigates the effects of thermal and mechanical induced pressure changes. The pressure following the completion of the transitional component of the pressurization phase will be approximately equal to the test pressure prescribed within the applicable hydrostatic test procedure. The monitoring phase immediately following the pressurization phase of the improved hydrostatic test method comprises a period of approximately 30 seconds, but can be more or less depending on the thermal and mechanical attributes of the test vessel. During the monitoring phase the test pressure within the vessel is maintained at a relatively constant pressure by a intensifying pump 26 allowing for the variable volume of intensification fluid within the test vessel. The constant pressure variable volume testing methodology when applied for a relatively short period of time immediately subsequent to the pressurization phase mitigates the thermal and mechanical pressure effects normally associated with traditional pressure decay testing allowing for the detection of leaks via direct measurement of the intensification fluid required to maintain the relatively constant pressure within the test vessel. In systems where there is a suitable intensification pump, such as the cement pump installed on most offshore drilling rigs, the constant pressure variable volume monitoring phase may be initiated subsequent to the intensification phase provided by the suitable alternate intensification pump. Providing a means of detecting leaks immediately subsequent to the pressure phase negates the requirement for a pressure decay monitoring phase thereby saving substantial time and money.

The amount of intensification fluid added by pump 26 in order to maintain instant pressure is measured by sensor 64 which monitors movement of piston 62 after initial pressurization to the desired test pressure.

Although the present invention and its advantages have been described in detail, it should be understood that various changes, substitutions and alterations may be made herein without departing from the spirit and scope of the invention as defined by the appended claims.

What is claimed is:

1. A method of testing for leaks in a closed hydraulic system comprising:
a. pressurizing the portion of the closed hydraulic system to a first pressure level,
b. maintaining a constant pressure within the portion of the closed hydraulic system to be tested, and
c. immediately measuring any amount of fluid added to or removed from the pressurized portion of the closed hydraulic system that is required to maintain the pressure within the portion to be tested at a constant level.

2. The method as claimed in claim 2 wherein the pressure is maintained constant by a intensifier pump driven by a variable displacement hydraulic pump.

3. The method as claimed in claim 1 wherein the intensifier pump includes an axially movable piston and the amount of fluid added to or removed from the portion of the portion of the closed hydraulic system is measured by measuring any displacement of the piston after the portion of the closed hydraulic system to be tested has been pressurized to the first pressure level.

4. The method as claimed in claim 1 further including step of raising the pressure within the portion of the closed hydraulic system to be tested to a second pressure level and immediately measuring any amount of fluid added to or removed from the portion of the blowout preventer to be tested in order to maintain a constant pressure at the second pressure level.

5. The method as claimed in claim 1 wherein the pressurizing step includes an initial pressurization phase and a transitional pressurization phase that mitigates the effects of thermal and mechanical induced pressure changes.
